(19) United States
(12) Patent Application Publication
(10) Pub. No.: US 2008/0135734 A1
(43) Pub. Date: Jun. 12, 2008

(54) Method and system for controlling an air-conditioning unit

(75) Inventors: Thomas NIEMANN, Delmenhorst (DE); Carsten HEILENKOTTER, Weyhe (DE)

Correspondence Address: COLLARD & ROE, P.C., 1077 NORTHERN BOULEVARD, ROSLYN, NY, 11576, US

(73) Assignee: Hella KGaA Hueck & Co.

(21) Appl. No.: 11/982,901

(22) Filed: Nov. 6, 2007

(30) Foreign Application Priority Data
Nov. 10, 2006 (DE) 10 2006 053 022.5

(51) Int. Cl. G01J 1/42

(52) U.S. Cl. 250/208.2

(57) ABSTRACT

In a method for controlling an air-conditioning unit, in which the incident solar radiation is captured by means of at least three spatially arranged sensors, the calculation of the incident solar radiation is performed on the basis of a vector representation of the incident solar radiation. In this way a particularly simple calculation method can be implemented, which requires a particularly small calculation effort.

The invention relates to the control of an air-conditioning unit, in which the incident solar radiation is captured by means of at least three spatially arranged sensors. The invention additionally relates to a corresponding system. The method and the system for controlling the air-conditioning unit are especially intended for use in powered vehicles.

In the printed documents DE 102 34 585 B4 and DE 103 12 311 A1, systems are described for detection of the position of the sun with three spatially arranged sensors. By the term spatial arrangement of the sensors, in particular a different configuration of the surface normals of the various sensors is understood, such that these are oriented in different spatial directions and a three-dimensional space can be realized via the configuration of the sensors. In DE 103 12 311 A1 a method for calculating the position of the sun and the radiation strength is described. Therein the angle of the sun's position to the sensors is taken into account in order to be able to make an accurate evaluation of the position of the sun. The calculation of trigonometric functions necessary for this is possible with micro-controllers, which can be integrated into appropriate control systems and sensors.

The invention addresses the problem of creating a method and a system of the type described previously, which are particularly cheap and simple to implement and manufacture.

The solution of this problem is effected with a method with the features of patent claim 1. According to the device the solution of the problem is effected with a device with the features of patent claim 7. Advantageous configurations of the invention are described in the dependent claims.

In a method for controlling an air-conditioning unit, in particular for an air-conditioning unit in a powered vehicle, in which the incident solar radiation is captured with at least three spatially arranged sensors, according to the substance of the invention the calculation of the incident solar radiation is performed on the basis of a vector representation of the incident solar radiation. In this way a particularly simple operation requiring little calculation is possible and the incident solar radiation can be calculated particularly simply and with a particularly small and cheap microprocessor.

The method is thereby preferably embodied with the exclusion of the use of trigonometric functions. Such trigonometric functions, i.e. the calculation of sine, cosine and tangent, require particularly high calculation power and hence the use of comparatively expensive micro-controllers. Preferably the position of the sun is represented using the direction of a vector and the radiation strength of the sun by the magnitude of the vector, and the incident solar radiation is calculated on this vector basis. By means of the purely vectorial representation, the calculation can be performed relatively simply. Preferably the current measured by a sensor is calculated as a scalar product of the normal vector of the sensor and the vector which describes the position of the sun and the radiation strength of the sun. It is thereby assumed that the sensors have a Lambertian detection characteristic. That means that the current generated is dependent on the angle between the vector to the light source and the surface normal vector. A low-angled light incidence results in a smaller quantity of light per unit surface and therefore also in a smaller current generated by the sensor.

In an especially preferred embodiment of the invention the evaluation of the currents measured by the at least three sensors takes place in a pre-formulated equation.

In a preferred extended embodiment of the invention, relevant surfaces in the vehicle interior are assigned to normal vectors proportional to the respective surface, and from the scalar product of the respective surface normals and the vectorial representation of the sun, power factors are calculated that contribute to the heating of the surfaces. On this basis it can then be estimated for the vehicle air-conditioning to what extent the vehicle or its passengers are heating up and as a counter measure the air temperature can be lowered and/or the air speed of the air-conditioning unit can be raised.

The system for controlling an air-conditioning unit with at least three spatially arranged sensors for implementing the above-mentioned method is characterized in that the system incorporates a calculation unit for calculating the incident solar radiation on the basis of a vectorial representation of the incident solar radiation. In this way a particularly cheap system can be manufactured, as the calculation unit is equipped with a relatively small and cheap micro-controller.

The sensors used in this system are preferably sensors with a Lambertian detection characteristic, which are oriented at various spatial angles and in this way realize a three-dimensional space. The calculation unit preferably incorporates memory units, in which the previously calculated coefficients for multiplication with the measurement values of the individual sensor elements are stored.

A further aspect of the invention relates to an air-conditioning unit with a system according to the invention for controlling the air-conditioning unit. Protection is further claimed for a powered vehicle with an air-conditioning unit with a system of this type according to the invention, which operates with the method according to the invention.

In the following the invention is explained in further detail with the aid of an exemplary embodiment illustrated in the drawing. In the individual schematic illustrations there are

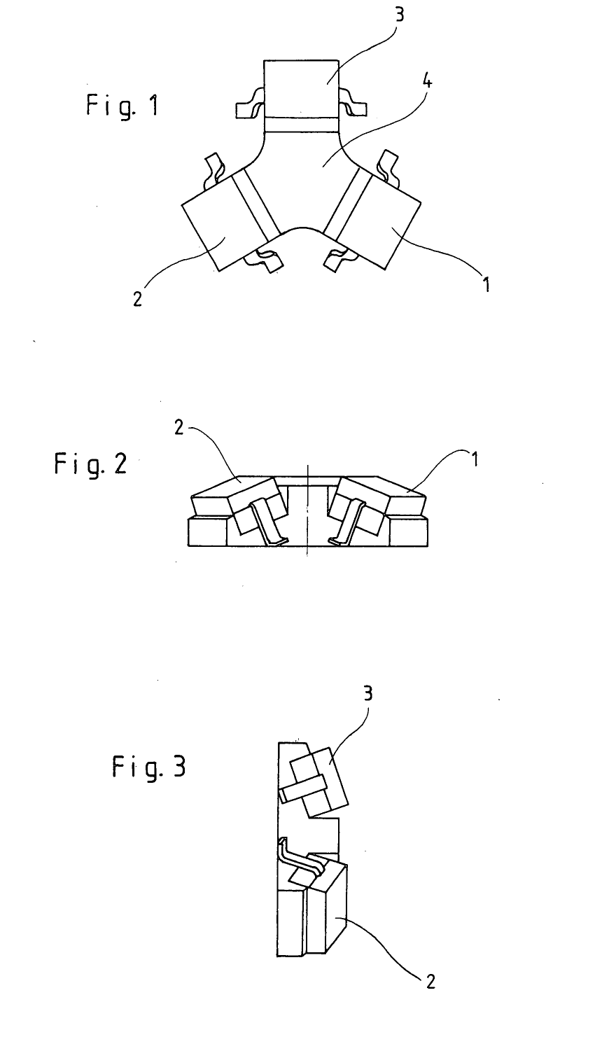

FIG. 1: a plan view of three sensors of a system according to the invention;

FIG. 2: a side view of FIG. 1;

FIG. 3: a second side view of FIG. 1;

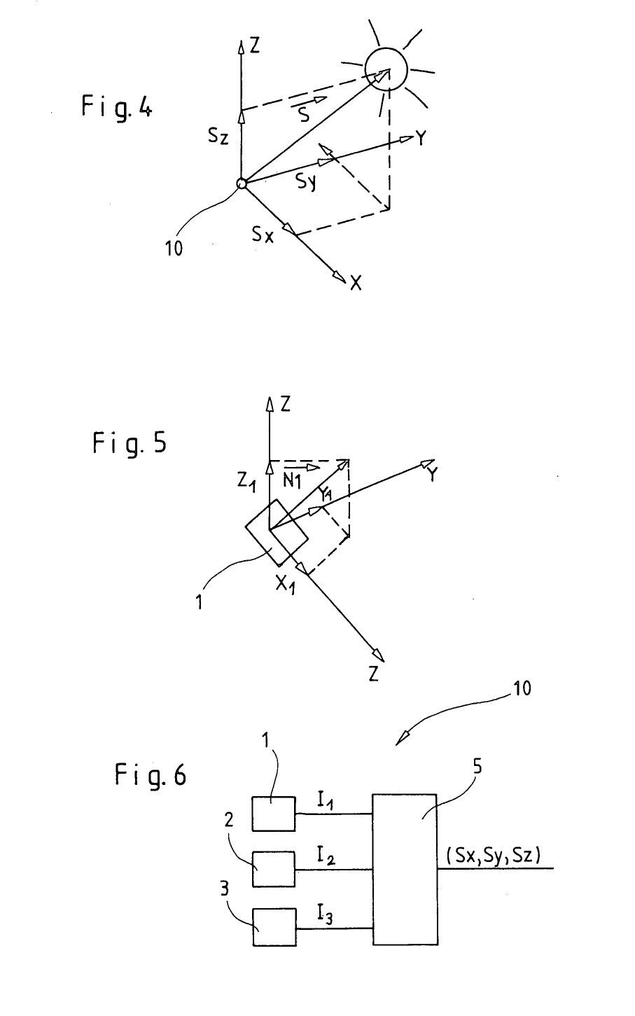

FIG. 4: a vectorial representation of the incident solar radiation;

FIG. 5: a vectorial representation of the surface of the normal vector of a sensor element and

FIG. 6: a schematic sketch of the circuit of the system according to the invention.

In FIG. 1 a plan view is shown of the three spatially arranged sensors 1, 2, 3 of the system according to the invention. In the illustrated configuration the sensors 1, 2, 3 are mounted on to a common body 4, in particular a MID-body. This is constructed as a unit in a triangular shape, and on the ends of this triangle the three sensors 1, 2, 3 are mounted. Each of the three sensors incorporates two connections.

In FIGS. 2 and 3 various side views of the sensor assembly 4 are illustrated, wherein in FIG. 2 the sensors 1 and 2 can be seen from the side, and in FIG. 3 the sensors 2 and 3 from the side. Therein can be seen in each case how the sensors are inclined towards one another and thereby the surface norms of the sensors are oriented in different directions and span a three-dimensional space.

In FIG. 4 following the system 10 according to the invention a vector “S” is shown. This vector “S” describes by its direction the position of the sun, and by its magnitude the strength of the radiation. In a Cartesian coordinate system with the coordinates “X”, “Y” and “Z” the vector “S” can be decomposed into orthogonal vectors Sₓ, S_{y}, S_{z}.

In FIG. 5 a sensor 1 is illustrated which has an assigned normal vector N₁ standing perpendicularly on its surface, or which is assigned to the sensor as appropriate. This normal vector can be decomposed into the components X₁, Y₁ and Z₁ in the underlying Cartesian coordinate system “X”, “Y” and “Z”. From the known spatial position of the individual sensor surfaces in relation to the chosen coordinate system (e.g. of the system according to the invention or of the vehicle to be air-conditioned), the individual components of the vectorial representation of the sun can then be calculated:

$${S}_{x} = \frac{( {y}_{3} {z}_{2} - {y}_{2} {z}_{3} ) {I}_{1} + ( {y}_{1} {z}_{3} - {y}_{3} {z}_{1} ) {I}_{2} + ( {z}_{1} {y}_{2} - {y}_{1} {z}_{2} ) {I}_{3}}{{x}_{1} ( {y}_{3} {z}_{2} - {y}_{2} {z}_{3} ) + {y}_{1} ( {x}_{2} {z}_{3} - {x}_{3} {z}_{2} ) + {z}_{1} ( {x}_{3} {y}_{2} - {x}_{2} {y}_{3} )}$$

$${S}_{y} = \frac{( {x}_{3} {z}_{2} - {x}_{2} {z}_{3} ) {I}_{1} + ( {x}_{1} {z}_{3} - {x}_{3} {z}_{1} ) {I}_{2} + ( {x}_{2} {z}_{1} - {x}_{1} {z}_{2} ) {I}_{3}}{{x}_{1} ( {y}_{3} {z}_{2} - {y}_{2} {z}_{3} ) + {y}_{1} ( {x}_{2} {z}_{3} - {x}_{3} {z}_{2} ) + {z}_{1} ( {x}_{3} {y}_{2} - {x}_{2} {y}_{3} )}$$

$${S}_{z} = \frac{( {x}_{3} {y}_{2} - {x}_{2} {y}_{3} ) {I}_{1} + ( {x}_{1} {y}_{3} - {x}_{3} {y}_{1} ) {I}_{2} + ( {x}_{2} {y}_{1} - {x}_{1} {y}_{2} ) {I}_{3}}{{x}_{1} ( {y}_{3} {z}_{2} - {y}_{2} {z}_{3} ) + {y}_{1} ( {x}_{2} {z}_{3} - {x}_{3} {z}_{2} ) + {z}_{1} ( {x}_{3} {y}_{2} - {x}_{2} {y}_{3} )}$$

In the equations Sₓ, S_{y}, S_{z} are the components of the vectorial representation of the sun, as shown in FIG. 4. X₁₋₃, Y₁₋₃ and Z₁₋₃ are the components of the normal vectors of the sensor elements, as shown in FIG. 5. I₁, I₂ and I₃ are the measurement values measured by the respective sensors, which in the case of a Lambertian detection characteristic of the sensors are proportional to the radiation strength. In order to further reduce the load on the micro-controller in operation, the coefficients for the multiplication with the measurement values of the individual sensor elements can be calculated in advance, so that the calculation simplifies as follows:

Sₓ=sₓ₁I₁+sₓ₂I₂+sₓ₃I₃

S_{y}=s_{y1}I₁+s_{y2}I₂+s_{y3}I₃

S_{z}=s_{z1}I₁+s_{z2}I₂+s_{z3}I₃

In FIG. 6 the system 10 according to the invention is schematically illustrated. The three sensors 1, 2, 3 supply measurement values I₁, I₂ and I₃ to a calculation unit 5, in which with comparatively low calculation effort the components Sₓ, S_{y}, S_{z} of the vectorial representation of the solar radiation are calculated.

In this way the effect of the sun on a surface can be calculated further. The surface of the body is for this purpose decomposed into separate surfaces, to which one of the normal vectors proportional to each surface can be assigned. The scalar product from each of the surface normals and the vectorial representation of the sun produce the power factors which contribute to the heating of the body. Thus e.g. for an air-conditioning unit it can be estimated to what extent the vehicle or its passengers are heating up. The air-conditioning unit can be regulated accordingly and the air temperature or the air speed modified.

1. Method for control of an air-conditioning unit, in which the incident solar radiation is captured by means of at least three spatially arranged sensors, wherein the calculation of the incident solar radiation is performed on the basis of a vector representation of the incident solar radiation.

2. Method according to claim 1, wherein the calculation is performed with the exclusion of the use of trigonometric functions.

3. Method according to claim 1, wherein the position of the sun is taken into account using the direction of a vector and the radiation strength of the sun using the magnitude of the vector.

4. Method according to claim 1, wherein the current measured by a sensor is calculated as a scalar product of the normal vector of the sensor and the vector describing position of the sun and radiation strength of the sun.

5. Method according to claim 1, wherein the evaluation of the currents measured by the at least three sensors takes place in a pre-formulated equation.

6. Method according to claim 1, wherein surfaces of a region to be air-conditioned are assigned to normal vectors proportional to the respective surface, and that the scalar product of the respective surface normals and the vectorial representation of the incident solar radiation is determined that is used for estimating the heating of these surfaces.

7. System for controlling an air-conditioning unit, with at least three spatially arranged sensors for implementing the method according to claim 1, wherein the system (10) incorporates a calculation unit (5) for calculating the incident solar radiation on the basis of a vector representation of the solar radiation.

8. System according to claim 7, wherein the calculation unit incorporates storage elements for storing coefficients calculated in advance for multiplication with the measurement values of the individual sensor elements.

9. Air-conditioning unit with a system with the features of patent claim 7.

10. Vehicle with an air-conditioning unit with a system for controlling the air-conditioning unit with the features of claim 7.
